(19) United States
(12) Patent Application Publication
(10) Pub. No.: US 2026/0220622 A1
(43) Pub. Date: Jul. 30, 2026

(54) SYSTEMS AND METHODS FOR REBALANCING DIGITAL ASSETS

(71) Applicant: American Deposit Management, LLC, Pewaukee, WI (US)

(72) Inventor: Yianni Pantazides, Pewaukee, WI (US)

(21) Appl. No.: 19/459,662

(22) Filed: Jan. 26, 2026

Related U.S. Application Data
(60) Provisional application No. 63/749,043, filed on Jan. 24, 2025.

(51) Int. Cl. G06Q 20/10; G06Q 40/06

(52) U.S. Cl. CPC G06Q 20/10; G06Q 40/06

(57) ABSTRACT

Methods and systems include an application-specific integrated circuit (ASIC) connected to a non-transitory computer-readable memory, wherein the memory has stored therein an account-specific criteria. The ASIC is trained, by a computer, to determine how and when to transfer digital assets amongst a plurality of systems to satisfy conditions set by the account-specific criteria, and to transfer the digital assets according to said determination.

### CROSS-REFERENCE TO RELATED APPLICATIONS

This application claims priority to U.S. Provisional Application No. 63/749,043, titled “SYSTEMS AND METHODS FOR REBALANCING DIGITAL ASSETS,” and filed on Jan. 24, 2025, the contents of which are hereby incorporated by reference in their entirety.

### FIELD

The following disclosure relates to systems and methods for transferring digital assets from a system to another system via a network.

### SUMMARY

In some aspects, the techniques described herein relate to a method of using an application-driven network system (ANS) for transferring digital currency (DC), including: training, by a computer, an account-specific criteria for the DC in a first system to generate a trained ANS; determining that the DC is nearing the account-specific criteria using the trained ANS; identifying a second system that can receive the DC and not be near the account-specific criteria, by the trained ANS; transferring the DC from the first system to the second system, by the ANS.

In some aspects, the techniques described herein relate to a method of using an application-driven network system (ANS) for transferring digital currency (DC), including: training, by a computer, an account-specific criteria for the DC in a first account to generate a trained ANS; determining that the DC is nearing the account-specific criteria using the trained ANS; identifying a second account that can receive the DC and not be near the account-specific criteria, by the trained ANS; transferring the DC from the first account to the second account, by the ANS.

In some aspects, the techniques described herein relate to a method of using an application-driven network system (ANS) for transferring non-fungible data (ND), including: training, by a computer, an account-specific criteria for the ND in a first system to generate a trained ANS; determining that the ND is nearing the account-specific criteria using the trained ANS; identifying a second system that can receive the ND and not be near the account-specific criteria, by the trained ANS; transferring the ND from the first system to the second system, by the ANS.

In some aspects, the techniques described herein relate to a method of using an application-driven network system (ANS) for transferring non-fungible data (ND), including: training, by a computer, an account-specific criteria for the ND in a first account to generate a trained ANS; determining that the ND is nearing the account-specific criteria using the trained ANS; identifying a second account that can receive the ND and not be near the account-specific criteria, by the trained ANS; transferring the ND from the first account to the second account, by the ANS.

In some aspects, the techniques described herein relate to an application-driven network system, including: an application-specific integrated circuit (ASIC); a non-transitory computer-readable memory (MEMORY) connected to the ASIC, wherein the MEMORY has stored therein an account-specific criteria; wherein the ASIC is trained, by a computer, to determine how and when to transfer digital assets amongst a plurality of systems to satisfy conditions set by the account-specific criteria; and wherein the ASIC transfers the digital assets according to the determination.

In some aspects, transferring the DC from the first system to the second system includes actual movement of the assets.

In some aspects, transferring the DC from the first system to the second system is not actual movement of the assets.

In some aspects, transferring the DC from the first system to the second system includes changing digital data within the computer.

In some aspects, the account-specific criteria includes a maximum value for the DC in a respective account.

In some aspects, the second system is selected to maximize a return on investment in a respective account.

In some aspects, transferring the DC from the first account to the second account includes actual movement of the assets.

In some aspects, transferring the DC from the first account to the second account is not actual movement of the assets.

In some aspects, transferring the DC from the first account to the second account includes changing digital data within the computer.

In some aspects, the account-specific criteria includes a maximum value for the DC in a respective account.

In some aspects, the second account is selected to maximize a return on investment in a respective account.

In some aspects, transferring the ND from the first system to the second system includes actual movement of the ND.

In some aspects, transferring the ND from the first system to the second system is not actual movement of the ND.

In some aspects, transferring the ND from the first system to the second system includes changing digital data within the computer.

In some aspects, the account-specific criteria includes a maximum value for the ND in a respective account.

In some aspects, the second system is selected to maximize a return on investment in a respective account.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 illustrates a schematic diagram of an example configuration of a system according to some embodiments.

FIG. 2 illustrates a flow chart of a method according to some embodiments.

FIG. 3 illustrates a flow chart of a method according to some embodiments.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

The accompanying drawings illustrate several example embodiments and are a part of the specification. Together with the following description, these drawings demonstrate and explain various principles of the present disclosure.

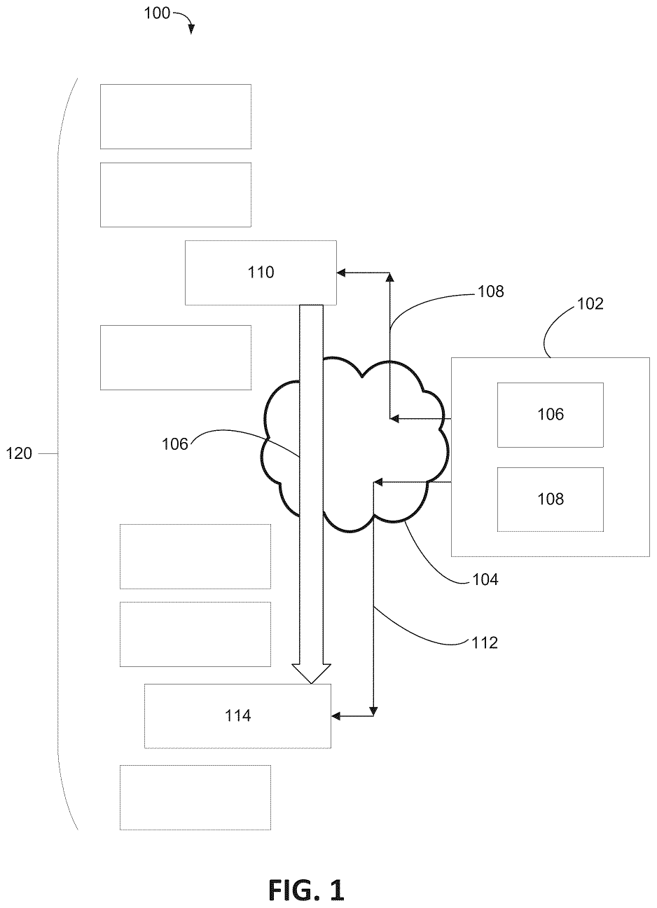

FIG. 1 is an exemplary schematic diagram of a system 100, which includes an application-driven network system 102 configured to communicate with a plurality of systems via a network 104. According to some embodiments, the application-driven network system 102 includes an application-specific integrated circuit (ASIC) 106 and a non-transitory computer-readable memory 108 that is connected to the ASIC 106. The memory has stored therein one or more account-specific criteria.

According to some embodiments, the ASIC 106 is trained by a computer to determine how and when to transfer digital assets amongst a plurality of systems to satisfy conditions set by the account-specific criteria.

According to some embodiments, the application-driven network system 102 or the ASIC 106 is configured (e.g., programmed, manually configured, hardwired, etc.) to determine how and when to transfer digital assets amongst a plurality of systems to satisfy conditions set by the account-specific criteria.

The application-driven network system 102 or the ASIC 106 is configured to transfer the digital assets according to the determination of how and when to transfer the digital assets. According to some embodiments, the “transfer of digital assets” include and/or is actual movement of the assets (e.g., monetary assets). According to some embodiments, the “transfer of digital assets” does not include actual movement of the assets. According to some embodiments, the “transfer of digital assets” is not actual movement of the assets. According to some embodiments, the “transfer of digital assets” include a computer system data manipulation and/or a change in a digital data within a computer system (e.g., a pointer changing a memory location or asset location of a data structure).

For example, application-driven network system 102 or the ASIC 106 identifies 108 a first system 110 (amongst a plurality of systems 120) to transfer out the digital assets therefrom. Then, the application-driven network system 102 or the ASIC 106 identifies 112 a second system 114 (amongst the plurality of systems 120) to transfer the digital assets into. Then, the application-driven network system 102 or the ASIC 106 transfers 116 (e.g., defunds the first system 110 and adds funds to the second system 114) the digital assets from the first system 110 to the second system 114.

According to some embodiments, the plurality of systems 120 are or includes a plurality of accounts. The first system 110 is a first account. The second system 114 is a second account. Further, the first and the second accounts are in the same system.

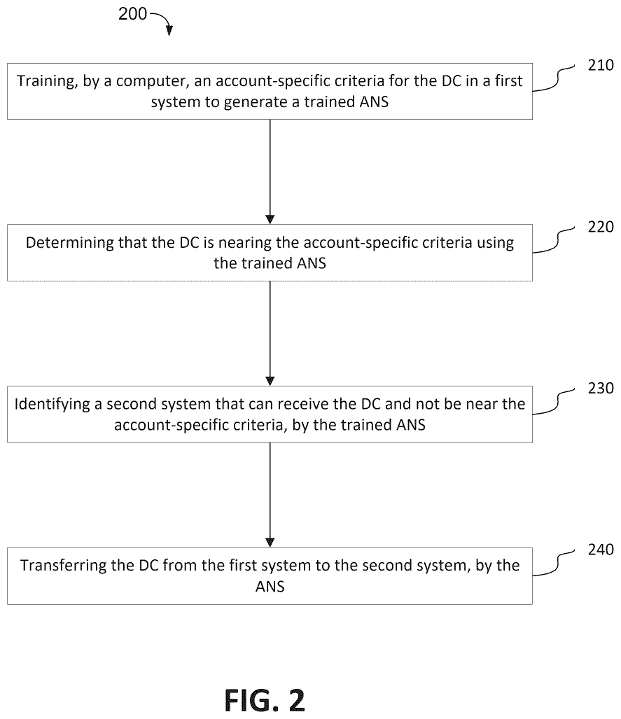

FIG. 2 is a flowchart of an example method 200 for using an application-driven network system (ANS) for transferring digital assets, such as for example, digital currency. At step 210, the method 200 includes training, by a computer, an account-specific criteria in a first system or account to generate a trained ANS. At step 220, the method 200 includes determining that the digital asset in a system or an account is nearing the account-specific criteria using the trained ANS. At step 230, the method 200 includes identifying another system or account that can better serve the needs (or requirements, limits, etc.) set by the account-specific criteria. That is, in the identification step 230, the trained ANS sets which system or account is to receive the digital assets and not be near the account-specific criteria. At step 240, the digital assets are transferred from the first to the second system or account.

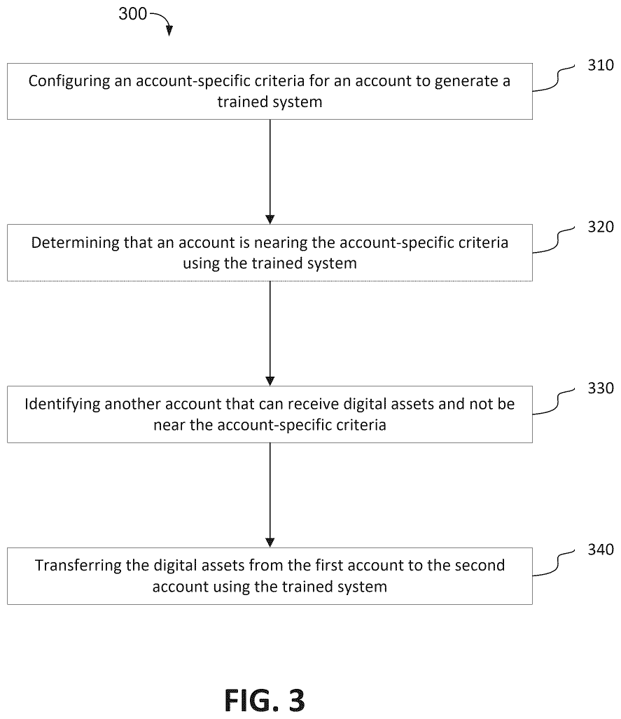

FIG. 3 is a flowchart of another example method 300 for transferring digital assets, such as for example, digital currency. At step 310, the method 300 includes configuring an account-specific criteria for an account to generate a trained system. At step 320, the method 300 includes determining that the digital asset in a particular account is nearing the account-specific criteria using the trained system. At step 330, the method 300 includes identifying another account that can better serve the needs (or requirements, limits, etc.) set by the account-specific criteria. That is, the identification step 330 sets which system or account is to receive the digital assets and not be near the account-specific criteria. At step 340, the digital assets are transferred from the first account to the second account.

The following specific example is according to some embodiments in this disclosure. The system and method according to the following example is directed towards using an application-driven network system for rebalancing.

Rebalancing is a process performed to generally ensure digital assets are distributed in an optimal manner. There can be multiple client and bank accounts within a network of systems with digital assets distributed throughout the systems. An example of the optimal distribution for rebalancing is to maximize an account's return on investment of digital assets, while preserving preset criteria (which can be specific to a client, account, etc.). For example, during a normal course of business, an account balance and/or a client account holding the digital assets can change in value. Rebalancing can be performed frequently, e.g., daily, to move digital assets to higher paying accounts within a network to endeavor to maximize return. Tools, such as an application-driven network system (ANS) which can include an application-specific integrated circuit (ASIC), can automate the rebalancing. These tools are specifically trained, by a computer, to simplify rebalancing processes. According to some embodiments, the rebalancing processes can require significant analysis and strategy that is performed at a speed which is not possible by a human mind.

Accordingly, according to this example, the system is trained, e.g., by a computer, to accomplish the rebalancing automatically. That is, the system follows directives set by an account-specific criteria of an account (or accounts) associated with one or more of a plurality of systems by determining if and when the digital currency balance in a particular account (or accounts) is at or nearing the limits set by the account-specific criteria. The system is configured to identify another one or more of the plurality of systems or another account (or accounts) that can receive the digital currency and not be near the account-specific criteria. The system then transfers the digital currency from the first system(s) to the second system(s) to follow the directives set by the account-specific criteria.

Accordingly, the system accomplishes rebalancing by moving digital assets (e.g., digital currency, funds, etc.) from a first account (e.g., a lower paying account) to second account (e.g., a higher paying account). The system can determine to accomplish rebalancing to accommodate a new or existing account offering a desirable rate(s). That is, according to some embodiments, the system will determine whether new or existing account offerings meet or exceed the desired goals set by the account-specific criteria.

Another example of the optimal distribution for rebalancing is to determine how to maximize an account's return on investment of digital assets, while preserving preset criteria (which can be specific to a client, account, etc.). For example, during a normal course of business, an account balance and/or a client account holding the digital assets can change in value. Rebalancing can be performed frequently, e.g., daily, to move digital assets to higher paying accounts within a network to endeavor to maximize return. Tools, such as an application-driven network system (ANS) which can include an application-specific integrated circuit (ASIC), can assess the necessary data to determine and make recommendations (e.g., suggestions) for performing the rebalancing. These tools are specifically trained, by a computer, to simplify rebalancing processes. According to some embodiments, the rebalancing processes can require significant analysis and strategy that is performed at a speed which is not possible by a human mind.

Accordingly, according to this example, the system is trained, e.g., by a computer, to make recommendations for accomplishing the rebalancing. That is, the system follows directives set by an account-specific criteria of an account associated with one of a plurality of systems by determining if and when the digital currency balance in a particular account (or accounts) is at or nearing the limits set by the account-specific criteria. The system is configured to identify another one or more of the plurality of systems or another account that can receive the digital currency and not be near the account-specific criteria. The system then outputs to a display device of a computer (or smart device) a recommendation for transferring the digital currency from the first system (or systems) to the second system (or systems) that would follow the directives set by the account-specific criteria.

Accordingly, the system accomplishes displaying an output of strategic recommendations for rebalancing for moving digital assets (e.g., digital currency, funds, etc.) from a first account(s) (e.g., a lower paying account) to second account(s) (e.g., a higher paying account). The system can determine the strategic “how” to accomplish rebalancing for accommodating a new or existing account offering a desirable rate(s). That is, according to some embodiments, the system will determine whether new or existing account offerings meet or exceed the desired goals set by the account-specific criteria.

Examples of an account-specific criteria include making sure that the account and digital asset meet the qualifications of the FDIC insurance, state insurance, collateral coverages, and one or more of these coverages. Accordingly, one of the limits which can be set by the account-specific criteria is that the balance of digital assets in any one account does not exceed $250,000. For example, this limit can be set to another amount, such as a max of $248,500 per client in any given account. If the account has multiple beneficiaries, the limit can be set to a different amount value. For example, an account that has two beneficiaries can have the limit set at $500,000, or another lower amount such as for example, $497,000 per client. For some, this limit is not set and the balance can exceed $250,000, or have no limit. Other types of account-specific criteria include account type, account structure, and/or balance restrictions. These are not meant to be an exhaustive list but rather some examples of restrictions for used in the rebalancing process.

For example, the rebalancing process can include determining a first account which has criteria (e.g., interest rate, balance, etc.) that are not ideal. The systems according to the embodiments disclosed herein are trained to assist in this determining step or configured to identify one or more accounts that should be considered to transferring digital assets therefrom (e.g., defunding the account).

According to some embodiments, an application-driven network system (ANS) is configured to use custom data paths based on specific needs and locations of security, certification, authentication, encryption, etc.

According to some embodiments, an application-specific integrated circuit (ASIC) is a custom integrated circuit designed and optimized for a specific purpose, which is different from a general computer circuit.

According to some embodiments, a digital asset is a property which can be represented in a digital format for transfer via a computer system and/or network. An example of a digital asset is digital currency, which is money that is represented in electronic accounts in a computer system that can be transferred via a computer network from one account to another account and/or from one system to another system.

According to some embodiments, one or more methods disclosed herein are automated by a trained computer system. According to some embodiments, one or more methods disclosed herein use a trained computer system. According to some embodiments, one or more methods disclosed herein are operated by a trained user using a trained computer system. According to some embodiments, one or more methods disclosed herein are automated by a trained artificial intelligence (AI) system.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method of using an application-driven network system (ANS) for transferring digital currency (DC), comprising:
training, by a computer, an account-specific criteria for the DC in a first system to generate a trained ANS;
determining that the DC is nearing the account-specific criteria using the trained ANS;
identifying a second system that can receive the DC and not be near the account-specific criteria, by the trained ANS; and
transferring the DC from the first system to the second system, by the ANS.

2. The method of claim 1, wherein transferring the DC from the first system to the second system includes actual movement of the assets.

3. The method of claim 1, wherein transferring the DC from the first system to the second system is not actual movement of the assets.

4. The method of claim 3, wherein transferring the DC from the first system to the second system includes changing digital data within the computer.

5. The method of claim 1, wherein the account-specific criteria includes a maximum value for the DC in a respective account.

6. The method of claim 1, wherein the second system is selected to maximize a return on investment in a respective account.

7. A method of using an application-driven network system (ANS) for transferring digital currency (DC), comprising:
training, by a computer, an account-specific criteria for the DC in a first account to generate a trained ANS;
determining that the DC is nearing the account-specific criteria using the trained ANS;
identifying a second account that can receive the DC and not be near the account-specific criteria, by the trained ANS; and
transferring the DC from the first account to the second account, by the ANS.

8. The method of claim 7, wherein transferring the DC from the first account to the second account includes actual movement of the assets.

9. The method of claim 7, wherein transferring the DC from the first account to the second account is not actual movement of the assets.

10. The method of claim 9, wherein transferring the DC from the first account to the second account includes changing digital data within the computer.

11. The method of claim 7, wherein the account-specific criteria includes a maximum value for the DC in a respective account.

12. The method of claim 7, wherein the second account is selected to maximize a return on investment in a respective account.

13. A method of using an application-driven network system (ANS) for transferring non-fungible data (ND), comprising:
training, by a computer, an account-specific criteria for the ND in a first system to generate a trained ANS;
determining that the ND is nearing the account-specific criteria using the trained ANS;
identifying a second system that can receive the ND and not be near the account-specific criteria, by the trained ANS; and
transferring the ND from the first system to the second system, by the ANS.

14. The method of claim 13, wherein transferring the ND from the first system to the second system includes actual movement of the ND.

15. The method of claim 13, wherein transferring the ND from the first system to the second system is not actual movement of the ND.

16. The method of claim 15, wherein transferring the ND from the first system to the second system includes changing digital data within the computer.

17. The method of claim 13, wherein the account-specific criteria includes a maximum value for the ND in a respective account.

18. The method of claim 13, wherein the second system is selected to maximize a return on investment in a respective account.

19. A method of using an application-driven network system (ANS) for transferring non-fungible data (ND), comprising:
training, by a computer, an account-specific criteria for the ND in a first account to generate a trained ANS;
determining that the ND is nearing the account-specific criteria using the trained ANS;
identifying a second account that can receive the ND and not be near the account-specific criteria, by the trained ANS; and
transferring the ND from the first account to the second account, by the ANS.

20. An application-driven network system, comprising:
an application-specific integrated circuit (ASIC);
a non-transitory computer-readable memory (MEMORY) connected to the ASIC, wherein the MEMORY has stored therein an account-specific criteria;
wherein the ASIC is trained, by a computer, to determine how and when to transfer digital assets amongst a plurality of systems to satisfy conditions set by the account-specific criteria; and
wherein the ASIC transfers the digital assets according to the determination.
